(19) United States
(12) Patent Application Publication
(10) Pub. No.: US 2024/0315478 A1
(43) Pub. Date: Sep. 26, 2024

(54) FLAT KETTLE HAVING VACUUM INTERLAYER

(71) Applicant: Hongbin TAN, Hunan (CN)

(72) Inventor: Hongbin TAN, Hunan (CN)

(21) Appl. No.: 18/125,725

(22) Filed: Mar. 23, 2023

(51) Int. Cl. A47J 27/21

(52) U.S. Cl. CPC A47J 27/21166

(57) ABSTRACT

Disclosed herein is a flat kettle having a vacuum interlayer, the flat kettle including an outer shell and an inner container, wherein the outer shell has a first chamber, and the lower end of the inner container is suspended in the first chamber; the inner container includes a container shell and an interlayer shell, the interlayer shell has a second chamber, the container shell has a third chamber, the container shell is suspended in the second chamber and seals the second chamber, the second chamber is vacuum, and the third chamber is in communication with the outside. According to the present invention, the inner container is located inside the outer shell, and the inner container is not required to be polished, so that the reduction of the heat insulation effect due to vacuum leakage caused by abrasions caused by polishing can be avoided.

### BACKGROUND OF THE INVENTION

The present invention relates to the technical field of daily necessities, in particular to a flat kettle having a vacuum interlayer.

In the situations that drinking water cannot be obtained easily when people go out for running, hiking, traveling, etc., in order to ensure normal intake of water, most of people will carry the drinking water or drinks with them. However, with the increase of the requirements for the quality of life, people often choose to carry hot water or other hot drinks when the ambient temperature is high, and to carry ice water or other ice drinks when the ambient temperature is low; in the high-temperature or low-temperature environment, within a period of time, thermal insulation kettles can ensure that temperatures of liquids in the kettles do not rise due to the high ambient temperature and do not decrease due to the low ambient temperature, and the temperatures of the liquids when the liquids are contained in the kettles are maintained. It is generally believed that the longer the heat insulation time of the thermal insulation kettles is, the higher the product quality is. In the prior art, the vacuum may be used for isolating heat exchange between the liquids and the environment so as to prolong the heat insulation time of the thermal insulation kettles.

Generally, in order to facilitate carrying, the thermal insulation kettles will be made into flat kettles; and during manufacturing, welding of the vacuum flat kettles is irregular welding, which has high requirements for the welding technology, and weak spots exist at welded portions such that some welded portions are prone to abrasion during subsequent polishing, resulting in leakage of the sealed vacuum isolation, which reduces the heat insulation effect and increases the reject ratio of products.

### BRIEF SUMMARY OF THE INVENTION

In order to overcome the defects in the prior art, the present invention provides a flat kettle having a vacuum interlayer.

The technical solution of the present invention is as follows:
the flat kettle having the vacuum interlayer comprises an outer shell and an inner container, wherein the outer shell has a first chamber, an open end of the inner container is fixed to an opening of the outer shell, and the lower end of the inner container is suspended in the first chamber; the inner container comprises a container shell and an interlayer shell, the interlayer shell has a second chamber, the container shell has a third chamber, the container shell is fixedly connected to the interlayer shell, the container shell is suspended in the second chamber and seals the second chamber, the third chamber is in communication with the outside, and the second chamber is vacuum; and a first hub is arranged around a side wall of the container shell, a second hub is arranged around a side wall of the interlayer shell, and the first hub and the second hub are configured to support the second chamber.

Further, in one embodiment, the container shell comprises an upper container shell and a lower container shell, the lower end of the upper container shell protrudes outwards to form a first boss, the upper end of the lower container shell protrudes outwards to form a second boss, and the first boss directly faces the second boss and is connected to the second boss in a welded manner to form the first hub; and the interlayer shell comprises an upper interlayer shell and a lower interlayer shell, the lower end of the upper interlayer shell protrudes outwards to form a third boss, the upper end of the lower interlayer shell protrudes outwards to form a fourth boss, and the third boss directly faces the fourth boss and is connected to the fourth boss in a welded manner to form the second hub.

Further, in one embodiment, the first hub and the second hub are horizontally staggered.

Further, in one embodiment, the open end of the inner container is fixed to the opening of the outer shell in a welded manner, and an open end of the interlayer shell is fixed to the neck of an open end of the container shell in a welded manner.

Further, in one embodiment, the top of the open end of the container shell is turned downwards to form a welding ring, an outer wall of the welding ring is in contact with an inner wall of an open end of the outer shell, and the container shell is fixed to the outer shell in a welded manner.

Further, in one embodiment, there is a distance between an inner wall of the welding ring and an outer wall of the neck of the container shell to form a groove.

Further, in one embodiment, the lower end of the container shell is in an upward protruding arc shape.

Further, in one embodiment, the outer shell, the interlayer shell and the container shell are all made of stainless steel materials, and the container shell is made of 316 stainless steel.

Further, in one embodiment, the outer shell is 0.7 mm thick, the interlayer shell is 0.5 mm thick, and the container shell is 0.5 mm thick.

Further, in one embodiment, each of the first boss, the second boss, the third boss and the fourth boss has the bending radian of 90°.

The present invention according to the above-mentioned solution has the beneficial effects as follows: in the present invention, the inner container having a vacuum layer is provided on a shell of the flat kettle having the vacuum interlayer, and an outer shell is arranged outside the inner container; and during polishing, the polished portion is the outer shell, the inner container is not required to be polished, so that welded portions of the inner container are not prone to abrasion during polishing, thereby preventing the problem of reduction of the heat insulation effect due to vacuum leakage caused by welding abrasions, reducing the welding difficulty requirement, and effectively increasing the product yield at the same time. The arrangement of the two hubs ensures that the second chamber cannot be shrunk under the atmospheric pressure and the second chamber is vacuum, and the vacuum does not conduct heat, which can remarkably improve the heat insulation effect of the flat kettle having the vacuum interlayer.

### BRIEF DESCRIPTION OF THE DRAWINGS

FIG. 1 is a schematic diagram of a section of the present invention;

FIG. 2 is an enlarged view at B in FIG. 1; and

FIG. 3 is an enlarged view at A in FIG. 1.

In the drawings, 1. outer shell; 2. container shell; 3. interlayer shell; 4. first chamber; 5. second chamber; 6. third chamber; 7. welding ring; 8. first boss; 9. second boss; 10. third boss; and 11. fourth boss.

### DETAILED DESCRIPTION OF THE INVENTION

The present invention is further described below in conjunction with accompanying drawings and embodiments. It should be noted that when one element is expressed as “fixed to” another element, it may be directly located on another element, or there may be one or more intermediate elements between them. When one element is expressed as “connected to” another element, it may be directly connected to another element, or there may be one or more intermediate elements between them. The terms “vertical”, “horizontal”, “left”, “right”, “inner”, “outer” and the like used herein are only for the purpose of descriptions. In the descriptions of the present invention, the terms “first” and “second” are only for the purpose of descriptions, and cannot be understood as indicating the relative importance or implicitly indicating the number of indicated technical features. Thus, unless otherwise specified, the features defined as “first” and “second” can explicitly or implicitly include one or more such features; and “a plurality of” means two or more. The term “comprising” and any variation thereof mean non-exclusive inclusion, and one or more other features, integers, steps, operations, units, components and/or combinations thereof may exist or be added.

In addition, unless otherwise explicitly specified and limited, the terms “mounting”, “connecting” and “connection” should be understood in a broad sense, for example, they may be fixed connection, and may also be detachable connection or integrated connection; they may be mechanical connection, and may also be electrical connection; and they may be direct connection, and may also be indirect connection by means of intermediate media or communication of the insides of two elements. All technical and scientific terms used herein have the same meanings as those generally understood by those skilled in the art of the present invention. The terms used herein are only for the purpose of describing specific embodiments and are not intended to limit the present invention. The term “and/or” used herein includes any and all combinations of one or more related listed items.

In addition, the technical features involved in the different embodiments of the present invention described below can be combined with each other as long as there is no conflict between them.

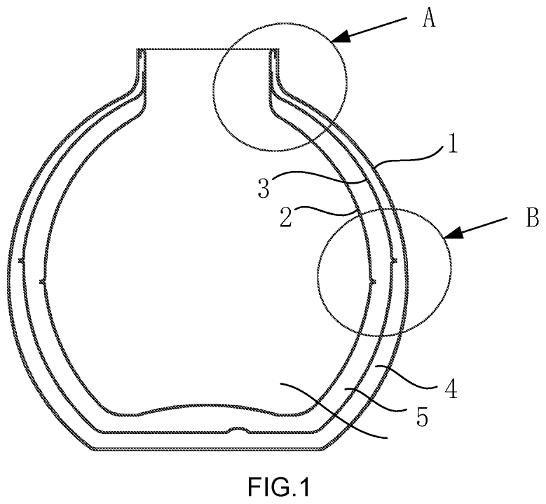

As shown in FIG. 1 and FIG. 3, the present invention provides an embodiment of a flat kettle having a vacuum interlayer, which is of a three-layer structure, the flat kettle comprising an outer shell 1 and an inner container, wherein the outer shell 1 has a first chamber 4, an open end of the inner container is welded to an opening of the outer shell 1 such that the inner container is fixed to the outer shell 1, and the lower end of the inner container is suspended in the first chamber 4; the inner container comprises a container shell 2 and an interlayer shell 3, the interlayer shell 3 has a second chamber 5, the container shell 2 has a third chamber 6, the container shell 2 is fixed to the interlayer shell 3 in a welded manner, an open end of the interlayer shell 3 is fixed to the neck of an open end of the container shell 2 in a welded manner, the container shell 2 is suspended in the second chamber 5 and seals the second chamber 5, the third chamber 6 is in communication with the outside, and the second chamber 5 is vacuum. A first hub is arranged around a side wall of the container shell 2, a second hub is arranged around a side wall of the interlayer shell 3, and the first hub and the second hub are configured to support the second chamber 5 to prevent the contact between the interlayer shell 3 and the lower end of the container shell 2 due to the fact that the vacuum second chamber 5 is shrunk due to extrusion of the atmospheric pressure. Various liquids or solids needing heat insulation, for example, hot water, juice, ice cubes, etc., can be added to the third chamber 6 via an opening of the third chamber 6. In this embodiment, except the opening, the liquid contained in the third chamber 6 is separated from the external environment by a layer of vacuum and a layer of air, namely, the first chamber 4 and the second chamber 5; and the vacuum does not conduct heat, and the air in the first chamber does not flow and is a bad conductor for heat, so that the flat kettle in this embodiment has the good heat insulation effect. Welding on the flat kettle in this embodiment is irregular welding, and weak spots may exist at some welded positions; after welding, in order to make the flat kettle beautiful or perform pretreatment for the subsequent paint spraying technology and other technologies, the welded flat kettle often needs to be polished. However, during polishing, the weak spots at some welded positions are prone to vacuum leakage due to polishing abrasions, thereby increasing the reject ratio. The welded positions of this embodiment are all located in the outer shell 1, and the welded positions of the inner container are not required to be polished, so that the vacuum leakage caused by the high temperature and the polishing abrasions can be avoided, the product yield is greatly increased, and meanwhile, the manufacturing procedure efficiency is improved.

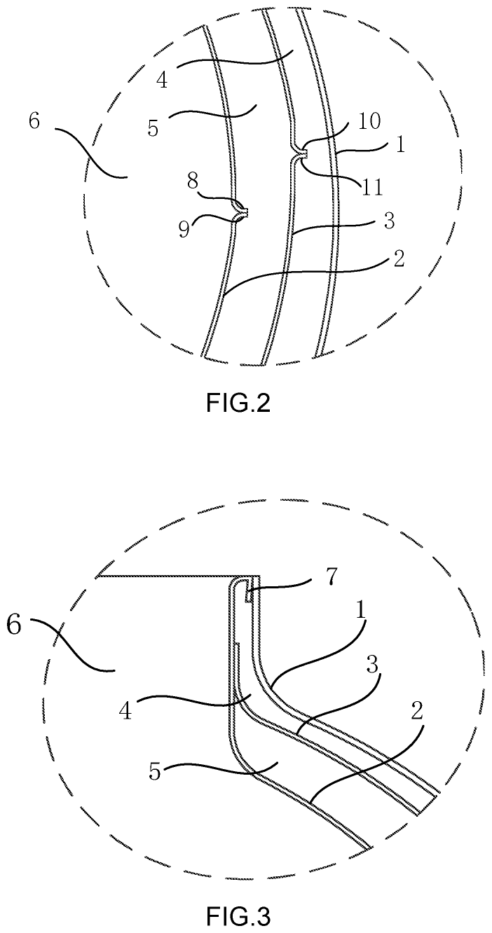

As shown in FIG. 2, in this embodiment, the container shell 2 comprises an upper container shell and a lower container shell, the lower end of the upper container shell protrudes outwards to form a first boss 8 having the bending radian of 90°, the upper end of the lower container shell protrudes outwards to form a second boss 9 having the bending radian of 90°, and the first boss 8 directly faces the second boss 9 and is connected to the second boss in a welded manner to form the first hub; and the interlayer shell 3 comprises an upper interlayer shell and a lower interlayer shell, the lower end of the upper interlayer shell protrudes outwards to form a third boss 10 having the bending radian of 90°, the upper end of the lower interlayer shell protrudes outwards to form a fourth boss 11 having the bending radian of 90°, and the third boss 10 directly faces the fourth boss 11 and is connected to the fourth boss in a welded manner to form the second hub. Each of the interlayer shell 3 and the container shell 2 is divided into an upper portion and a lower portion which are welded into a whole, and machining is convenient; and meanwhile, the thicknesses at the welded positions on the side walls of the interlayer shell 3 and the container shell 2 are increased by means of the bosses at the connected positions of the upper and lower portions, so that the formed first hub and the formed second hub have the higher material strength, which prevents the second chamber 5 from being shrunk under the effect of factors such as the atmospheric pressure and the like. Meanwhile, the thicknesses at the welded positions are increased by the bosses, which effectively reduces the welding difficulty and helps to increase the production rate of products.

In this embodiment, the first hub and the second hub are horizontally staggered such that welding is more convenient.

As shown in FIG. 3, in this embodiment, the top of the open end of the container shell 2 is turned downwards to form a welding ring 7, an outer wall of the welding ring 7 is welded to an inner wall of an open end of the outer shell 1 so as to fix the inner container to the outer shell 1, and quick welding, fixing and positioning are realized by means of the welding ring 7, which makes welding more convenient. In addition, there is a distance between an inner wall of the welding ring 7 and an outer wall of the neck of the container shell 2 to form a groove, so that the container shell 2 is just connected to and makes contact with the outer shell 1 by means of the top layer of the open end, the area contact between the container shell 2 and the outer shell 1 is reduced as much as possible, the heat exchange between the third chamber 6 and the external environment is reduced as much as possible, and the heat insulation effect of the flat kettle is improved.

In one embodiment, the lower end of the container shell 2 is in an upward protruding arc shape, so that there is always a gap between the lower end of the container shell 2 and the lower end of the interlayer shell 3 which are not in contact, the change caused by the atmospheric pressure and the gravity on the shape of the second chamber 5 is reduced, and the vacuum heat insulation is ensured.

In this embodiment, the outer shell 1 is made of stainless steel which is 0.7 mm thick, the interlayer shell 3 is made of stainless steel which is 0.5 mm thick, and particularly, the container shell 2 is made of 316 stainless steel which is 0.5 mm thick. The third chamber 6 is a chamber for containing the liquid, so that the container shell 2 needs to be made of the food-grade stainless steel, thereby ensuring the hygiene and preventing food contamination. The stainless steel has the excellent rust resistance and also has the high material strength to form the first chamber 4, the third chamber 6 and the vacuum second chamber 5, thereby ensuring that the lower end of the container shell 2, the lower end of the interlayer shell 3 and the lower end of the outer shell 1 are not in contact, reducing the heat conduction contact area, greatly reducing the heat exchange between the third chamber 6 and the external environment by means of the properties of poor heat conduction of the air and non-conduction of heat by the vacuum, and improving the heat insulation effect of the flat kettle.

It should be understood that for those of ordinary skill in the art, improvements or conversions may be made according to the above-mentioned descriptions, and all the improvements and conversions should fall within the scope of protection of the claims of the present invention.

The present invention patent is described demonstratively above in conjunction with drawings, it is obvious that the realization of the present invention patent is not limited by the above-mentioned manner, and any improvement made by means of the method concept and the technical solution of the present invention patent, or the direct application of the concept and the technical solution of the present invention patent to other situations without involving any improvement should fall within the scope of protection of the present invention.

What is claimed is:

1. A flat kettle having a vacuum interlayer, the flat kettle comprising an outer shell and an inner container, wherein
the outer shell has a first chamber, an open end of the inner container is fixed to an opening of the outer shell, and the lower end of the inner container is suspended in the first chamber;
the inner container comprises a container shell and an interlayer shell, the interlayer shell has a second chamber, the container shell has a third chamber, the container shell is fixedly connected to the interlayer shell, the container shell is suspended in the second chamber and seals the second chamber, the third chamber is in communication with the outside, and the second chamber is vacuum; and
a first hub is arranged around a side wall of the container shell, a second hub is arranged around a side wall of the interlayer shell, and the first hub and the second hub are configured to support the second chamber.

2. The flat kettle according to claim 1, wherein the container shell comprises an upper container shell and a lower container shell, the lower end of the upper container shell protrudes outwards to form a first boss, the upper end of the lower container shell protrudes outwards to form a second boss, and the first boss directly faces the second boss and is connected to the second boss in a welded manner to form the first hub; and
the interlayer shell comprises an upper interlayer shell and a lower interlayer shell, the lower end of the upper interlayer shell protrudes outwards to form a third boss, the upper end of the lower interlayer shell protrudes outwards to form a fourth boss, and the third boss directly faces the fourth boss and is connected to the fourth boss in a welded manner to form the second hub.

3. The flat kettle according to claim 2, wherein the first hub and the second hub are horizontally staggered.

4. The flat kettle according to claim 1, wherein the open end of the inner container is fixed to the opening of the outer shell in a welded manner, and an open end of the interlayer shell is fixed to the neck of an open end of the container shell in a welded manner.

5. The flat kettle according to claim 4, wherein the top of the open end of the container shell is turned downwards to form a welding ring, an outer wall of the welding ring is in contact with an inner wall of an open end of the outer shell, and the container shell is fixed to the outer shell in a welded manner.

6. The flat kettle according to claim 5, wherein there is a distance between an inner wall of the welding ring and an outer wall of the neck of the container shell to form a groove.

7. The flat kettle according to claim 1, wherein the lower end of the container shell is in an upward protruding arc shape.

8. The flat kettle according to claim 7, wherein the outer shell, the interlayer shell and the container shell are all made of stainless steel materials, and the container shell is made of 316 stainless steel.

9. The flat kettle according to claim 8, wherein the outer shell is 0.7 mm thick, the interlayer shell is 0.5 mm thick, and the container shell is 0.5 mm thick.

10. The flat kettle according to claim 2, wherein each of the first boss, the second boss, the third boss and the fourth boss has the bending radian of 90°.
